(19) United States
(12) Patent Application Publication
(10) Pub. No.: US 2023/0227284 A1
(43) Pub. Date: Jul. 20, 2023

(54) SHEET DISCHARGE DEVICE AND IMAGE SCANNING APPARATUS

(71) Applicant: BROTHER KOGYO KABUSHIKI KAISHA, Nagoya (JP)

(72) Inventors: Hiroaki SHIGENO, Nagoya (JP); Yuichiro ICHINOSE, Kariya (JP)

(73) Assignee: BROTHER KOGYO KABUSHIKI KAISHA, Nagoya (JP)

(21) Appl. No.: 18/150,232

(22) Filed: Jan. 5, 2023

(30) Foreign Application Priority Data
Jan. 14, 2022 (JP) 2022-004058

(51) Int. Cl. B65H 29/12; H04N 1/00

(52) U.S. Cl. CPC B65H 29/125; H04N 1/00631; H04N 1/00602; H04N 1/00559; B65H 2515/81; B65H 2404/1431; B65H 2404/1114

(57) ABSTRACT

A follow roller nips a sheet with a discharge roller. The follow roller is harder than the discharge roller. A paddle is rotatable together with the follow roller. The paddle includes protrusions and recesses arranged alternately in a circumferential direction of an axis of the follow roller. Each of the protrusions protrudes farther radially outward than an outer circumference of the follow roller to contact the sheet. Each of the recesses is recessed radially inward between two of the protrusions adjacent to each other in the circumferential direction. A groove is located between the follow roller and the paddle in a width direction parallel to a direction in which the axis extends. The groove is located at a same position as an end of the discharge roller in the width direction. The groove is recessed one round farther radially inward than the outer circumference of the follow roller.

### REFERENCE TO RELATED APPLICATIONS

This application claims priority from Japanese Patent Application No. 2022-004058 filed on Jan. 14, 2022. The entire content of the priority application is incorporated herein by reference.

### BACKGROUND ART

A recording medium feeding device as an example of a sheet discharge device is known.

### DESCRIPTION

A recording medium feeding device includes a first rotating member and a second rotating member. The second rotating member has a rotating member main body and a paddle. The rotating member main body is rotatable about an axis. The paddle rotates integrally with the rotating member main body. The paddle has protrusions and recesses that are alternately arranged in the circumferential direction of the axis. Each protrusion protrudes radially from the outer circumference of the rotating member main body and is configured to contact a recording medium. Each recess is radially recessed between two protrusions that are adjacent in the circumferential direction.

The first rotating member is covered with, for example, a rubber material. The second rotating member is made of, for example, plastic. That is, the rotating member main body is harder than the first rotating member.

The edge in the width direction parallel to the axis of the first rotating member is separated from the paddle. The outer circumference of the rotating member main body is a cylindrical surface that extends in the width direction to the paddle without steps or unevenness.

In such a sheet discharge device, the first rotating member rotates to apply a conveyance force to the recording medium to discharge the same. The rotating member main body nips the recording medium together with the first rotating member and rotates by following rotation of the first rotating member. At this time, the paddle kicks out the trailing edge of the recording medium with the protrusions and recesses, thereby suppressing discharge failure of the recording medium.

However, in the recording medium feeding device described above, the widthwise edge of the first rotating member, which is softer than the rotating member main body, is separated from the paddle, and the outer circumference of the rotating member main body is a cylindrical surface extending to the paddle in the width direction without steps or unevenness. Due to this configuration, the portion of the recording medium located outside the first rotating member in the width direction can be easily warped away from the protrusions and recesses.

As a result, in this recording medium feeding device, kicking of the trailing edge of the recording medium by the protrusions and recesses tends to be weak, and consequently, it may become difficult to suppress a discharge failure of the recording medium.

In view of the foregoing, an example of an object of this disclosure is to provide a sheet discharge device and an image scanning apparatus configured to suppress a sheet discharge failure.

According to one aspect, this specification discloses a sheet discharge device. The sheet discharge device includes a discharge roller, a follow roller, a paddle, and a groove. The discharge roller is rotatable to apply a conveyance force to a sheet and discharge the sheet. The follow roller is rotatable about an axis. The follow roller is configured to nip the sheet with the discharge roller and to rotate by following rotation of the discharge roller. The follow roller is harder than the discharge roller. The paddle is rotatable together with the follow roller. The paddle includes protrusions and recesses arranged alternately in a circumferential direction of the axis. Each of the protrusions protrudes farther radially outward than an outer circumference of the follow roller to contact the sheet. Each of the recesses is recessed radially inward between two of the protrusions adjacent to each other in the circumferential direction. The groove is located between the follow roller and the paddle in a width direction. The width direction is parallel to a direction in which the axis extends. The groove is located at a same position as an end of the discharge roller in the width direction. The groove is recessed one round farther radially inward than the outer circumference of the follow roller. Thus, the end of the discharge roller in the width direction presses the sheet toward the groove at a position between the follow roller and the paddle. Here, the discharge roller is softer than the follow roller. Thus, the sheet warps such that a portion of the sheet located outside the follow roller in the width direction enters the groove and approach the protrusions and the recesses. Thus, it is unlikely that kicking of a trailing edge of the sheet by the protrusions and the recesses is weakened. As a result, the sheet discharge device suppresses problems that the trailing edge of the sheet stays near the follow roller, that the leading edge of the subsequent sheet slips under the trailing edge of the staying sheet to change the discharge order of the sheets, and that the subsequent sheet collides with the trailing edge of the staying sheet to cause damage or jamming of the sheet. Thus, the sheet discharge device suppresses discharge failures of the sheet.

According to another aspect, this specification also discloses an image scanning apparatus. The image scanning apparatus includes an image scanner and a sheet discharge device. The image scanner is configured to scan an image on a sheet. The sheet discharge device is configured to discharge the sheet. The image scanning apparatus includes the sheet discharge device having the above-described configuration, and thus has similar advantages.

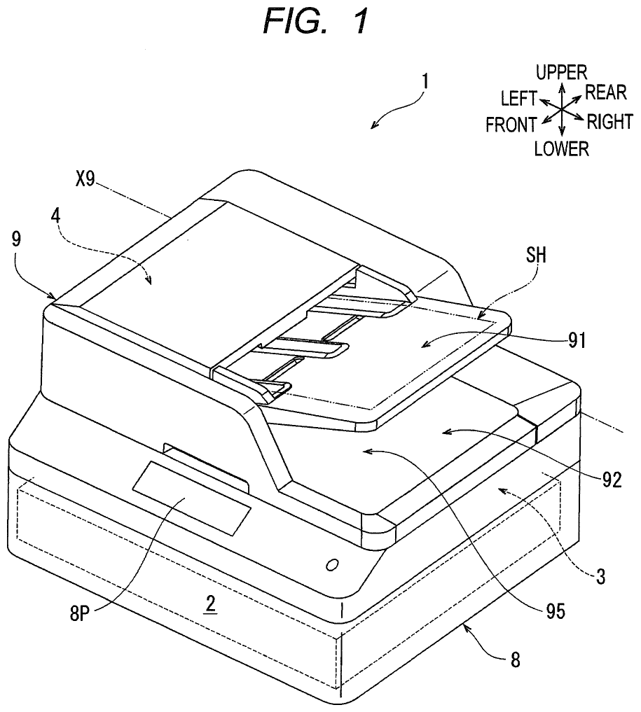

FIG. 1 is a perspective view of an image scanning apparatus.

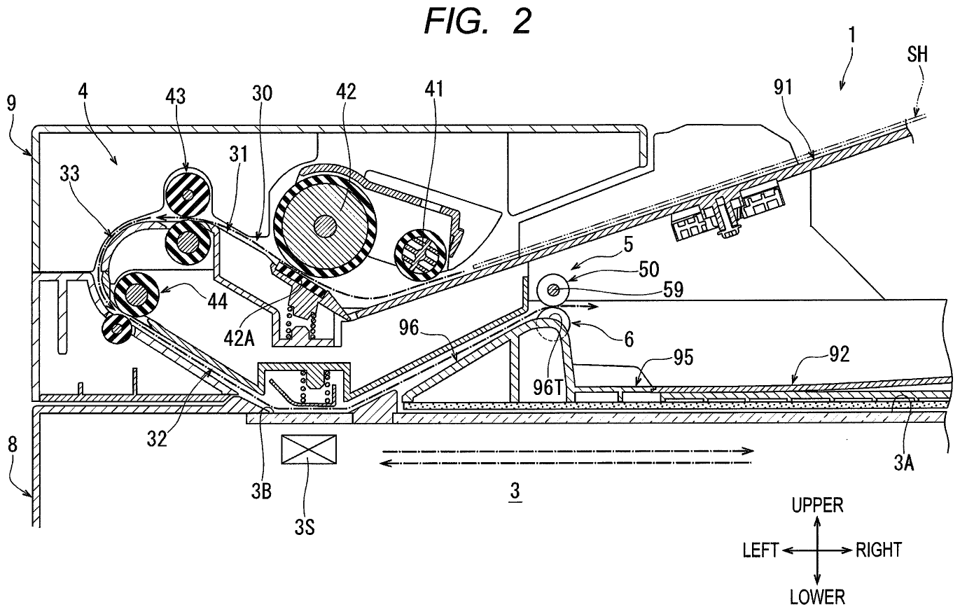

FIG. 2 is a schematic partial sectional view of the image scanning apparatus.

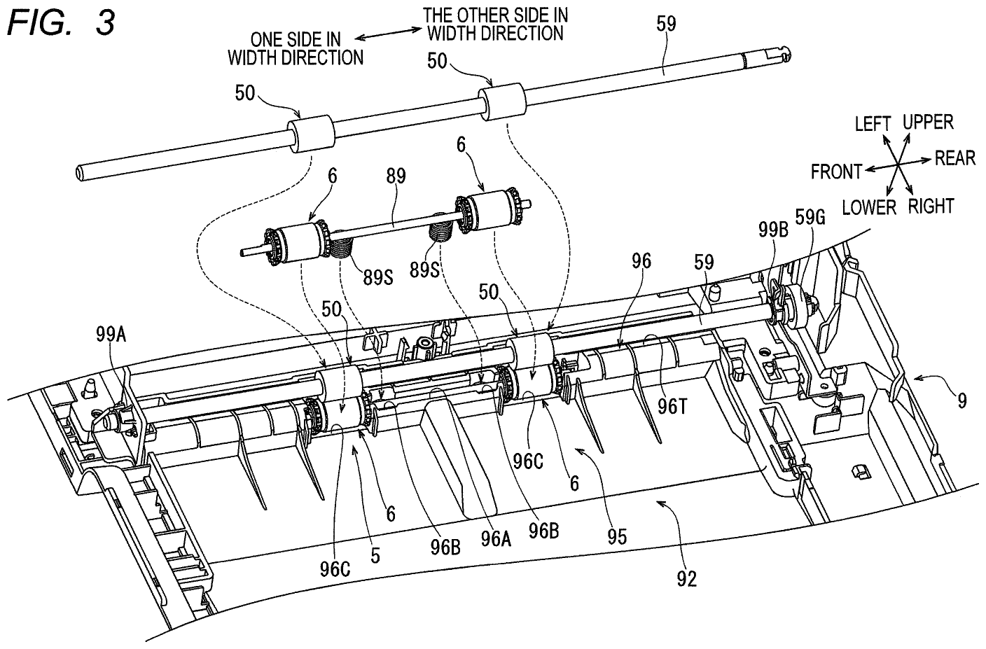

FIG. 3 is a partial perspective view mainly showing a discharge roller, a follow roller, and a paddle of the image scanning apparatus.

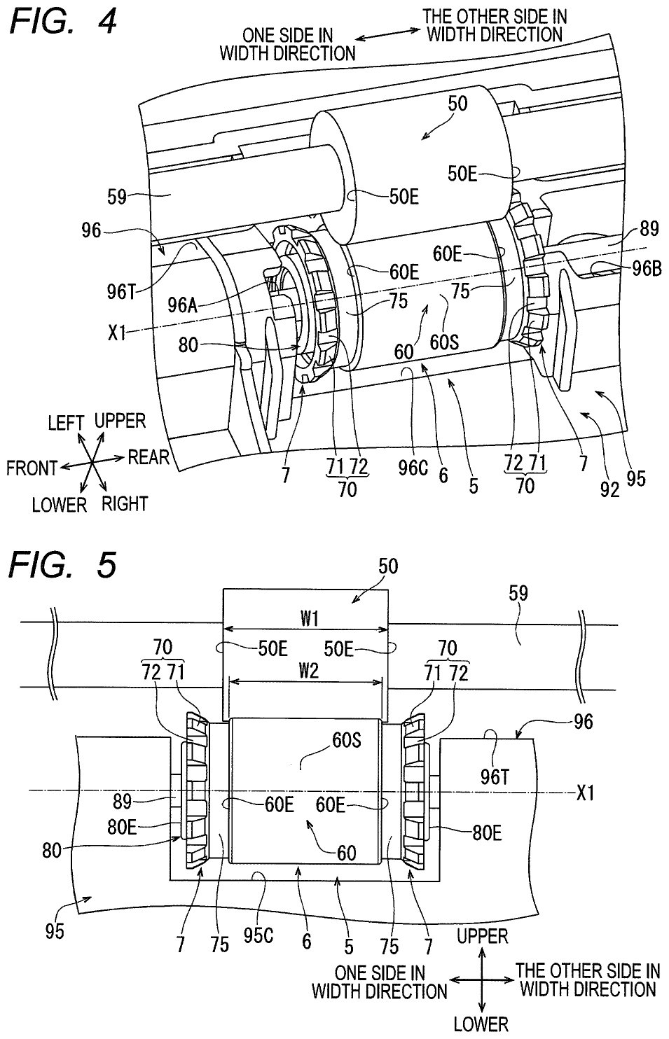

FIG. 4 is a partially enlarged perspective view mainly showing the discharge roller, the follow roller, and the paddle.

FIG. 5 is a partially enlarged front view mainly showing the discharge roller, the follow roller, and the paddle.

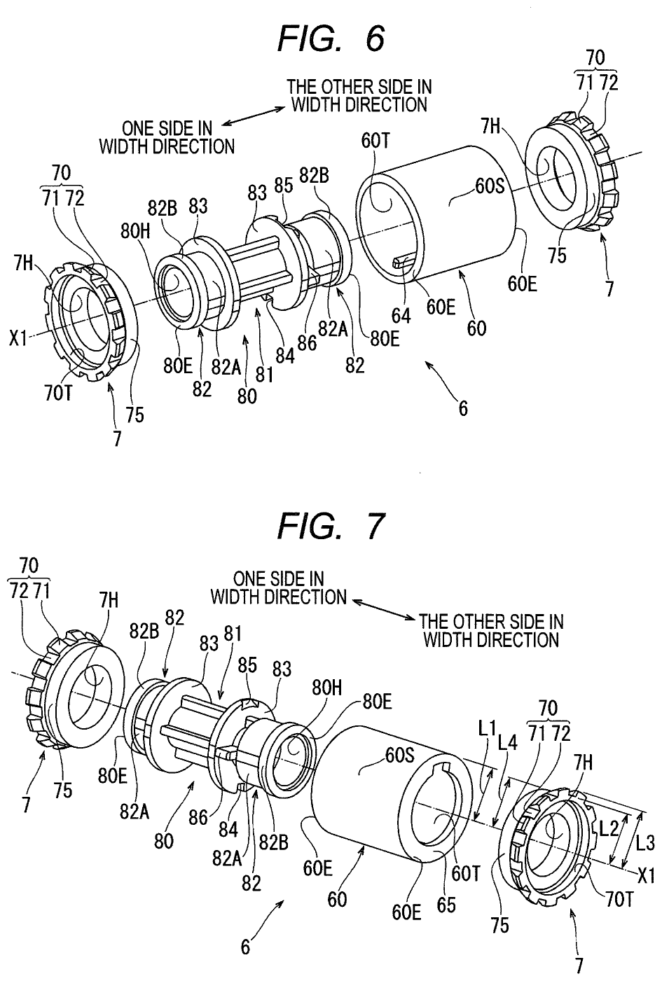

FIG. 6 is an exploded perspective view of the follow roller, the paddle, and a holder.

FIG. 7 is an exploded perspective view of the follow roller, the paddle, and the holder.

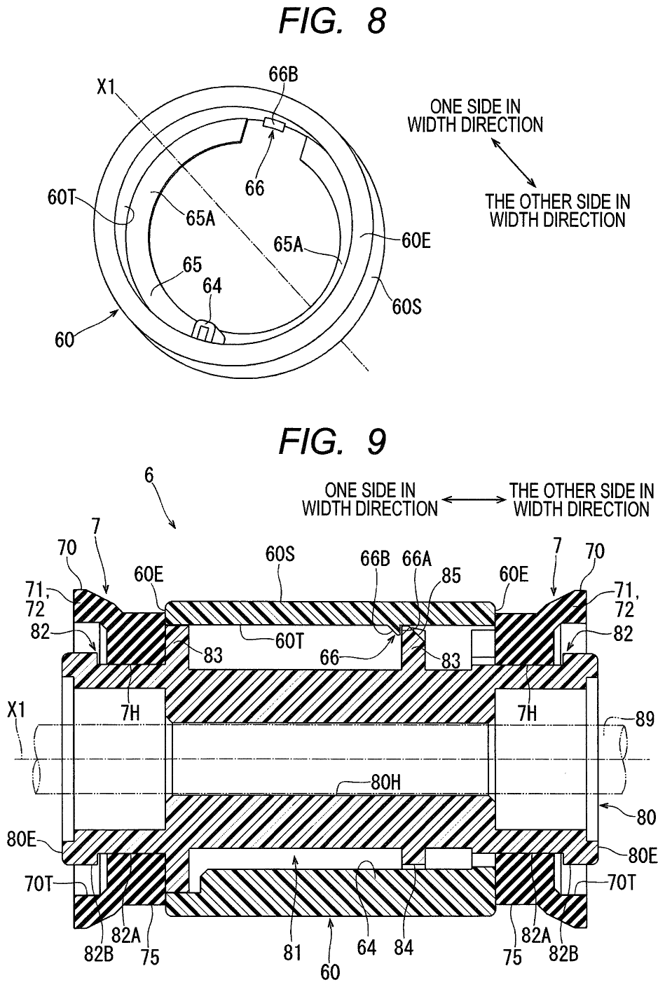

FIG. 8 is a perspective view of the follow roller showing an anti-rotation protrusion, a contact portion, and an engagement portion.

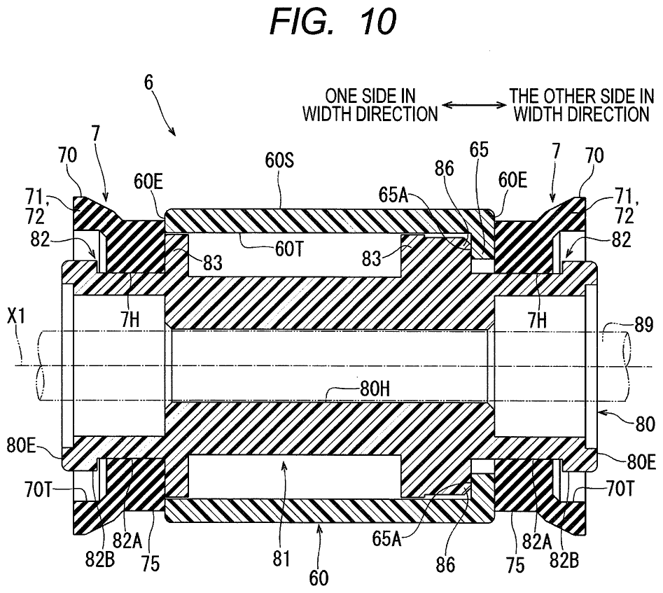

FIG. 9 is a cross-sectional view of the follow roller, the paddle, and the holder, including cross-sections of the engagement portion, an anti-rotation recess, and the anti-rotation protrusion.

FIG. 10 is a cross-sectional view of the follow roller, the paddle, and the holder, including a cross-section of the contact portion.

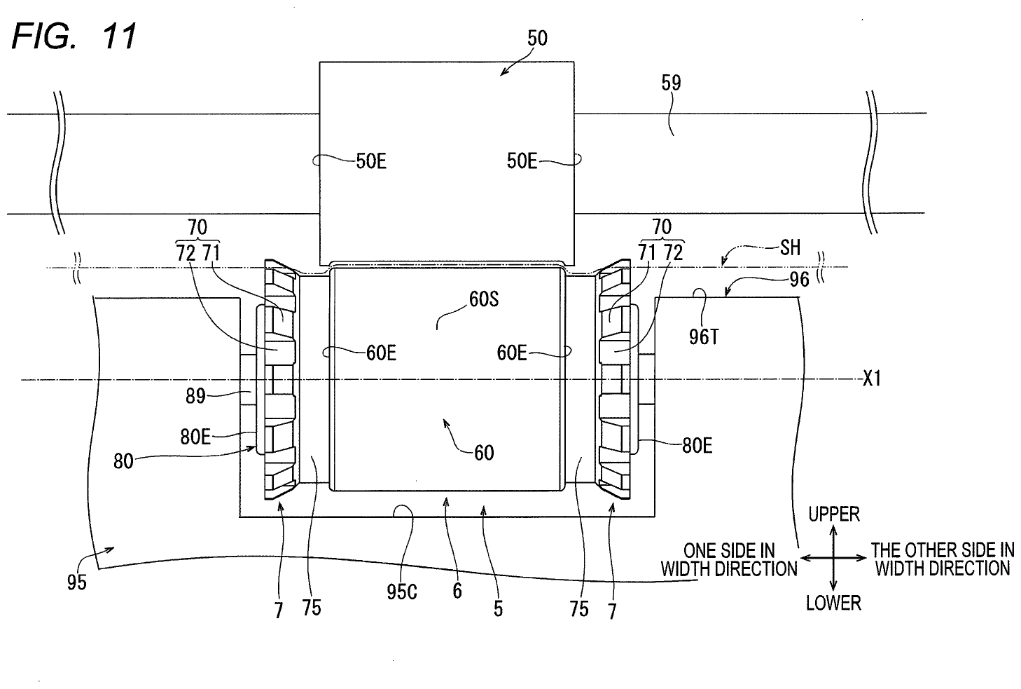

FIG. 11 is a partially enlarged front view similar to FIG. 5, and is a view for illustrating kicking out of a trailing edge of a sheet by the paddle.

Hereinafter, an embodiment will be described with reference to the drawings.

An image scanning apparatus 1 according to an embodiment is shown in FIG. 1. A sheet discharge device 5 of the embodiment provided in the image scanning apparatus 1 is shown in FIGS. 2 to 5.

In FIG. 1, the side of an operation panel 8P of the image scanning apparatus 1 is defined as front. The left side when facing the operation panel 8P is defined as a left side. A front-rear direction, a left-right direction, and an upper-lower direction shown in FIG. 2 and subsequent figures correspond to the directions shown in FIG. 1.

<Overall Configuration>

As shown in FIG. 1, the image scanning apparatus 1 includes a main body 8 and a cover 9. The main body 8 is a flat, substantially box-shaped body. The operation panel 8P such as a touch panel is located on the front surface of the main body 8. The main body 8 accommodates a print engine (image forming section) 2 in its lower portion. The print engine 2 forms an image on a sheet by an inkjet method, a laser method, and so on.

As shown in FIG. 2, the main body 8 accommodates an image scanner (image reading section) 3 in its upper portion. The image scanner 3 has a document support surface 3A, a reading surface 3B, a reading sensor 3S, and a scanning mechanism (not shown).

The document support surface 3A is an upper surface of a large-area platen glass located on the upper surface of the main body 8. The reading surface 3B is an upper surface of a platen glass that is located to the left of the document support surface 3A on the upper surface of the main body 8 and that is elongated in the front-rear direction.

The document support surface 3A supports a document to be read. Documents to be read are sheets such as paper and OHP sheets, books, and so on. The reading surface 3B is used when a conveyor 4 described later operates.

The reading sensor 3S is a well-known image reading sensor such as a CIS (Contact Image Sensor) or a CCD (Charge Coupled Device), and is elongated in the front-rear direction. The reading sensor 3S is located below the document support surface 3A and the reading surface 3B.

When the image scanner 3 reads an image of a document supported on the document support surface 3A, the reading sensor 3S reads the image of the document in a line in the front-rear direction, that is, in a main scanning direction, while moving rightward, that is, in a sub-scanning direction, from below the left edge of the document support surface 3A by an operation of a scanning mechanism (not shown). When the reading sensor 3S moves to a position below the right edge of the document support surface 3A, the reading sensor 3S finishes reading the image and returns to a standby position by the operation of the scanning mechanism (not shown).

When the conveyor 4 described later operates, the reading sensor 3S moves to a stationary reading position below the reading surface 3B by the operation of the scanning mechanism (not shown), and stop there.

As shown in FIG. 1, the cover 9 is located above the main body 8. The rear end of the cover 9 is connected to the rear end of the main body 8 via a hinge (not shown). The cover 9 is swingable about a swing axis X9 extending in the left-right direction.

As shown in FIG. 2, the cover 9 has a base member 95 made of resin. The lower surface of the base member 95 forms the bottom surface of the cover 9. The bottom surface of the cover 9 has a size of capable of covering the entire upper surface of the main body 8. The lower surface of the base member 95 of the cover 9 covers the document placed on the document support surface 3A.

Although not shown, when a user swings the cover 9 upward and rearward about the swing axis X9, the cover 9 open the document support surface 3A. In this state, the user places a document on the document support surface 3A and takes out the document.

As shown in FIGS. 1 and 2, the cover 9 has a supply tray 91 and a discharge tray 92. The supply tray 91 and the discharge tray 92 are located at the right portion of the cover 9.

The upper surface of the right portion of the base member 95 forms the discharge tray 92. The supply tray 91 is located above the discharge tray 92. The supply tray 91 supports sheets SH to be read in a stacked state.

In this embodiment, an object whose image is read using the document support surface 3A is referred to as a document, and an object whose image is read while being conveyed by the conveyor 4 is described as a sheet SH. The document and the sheet SH may be substantially the same.

As shown in FIG. 2, the cover 9 has the conveyor 4 and a conveyance guide 30. The conveyor 4 and the conveyance guide 30 are located inside the left portion of the cover 9.

The conveyor 4 includes a feed roller 41, a separation roller 42, a separation pad 42A, a first conveyance roller pair 43, and a second conveyance roller pair 44, which are well known. The image scanning apparatus 1 also includes the sheet discharge device 5 that constitutes a part of the conveyor 4.

The feed roller 41 faces the left end of the supply tray 91 from above. The separation roller 42 and the separation pad 42A are located to the left of the feed roller 41.

The first conveyance roller pair 43 and the second conveyance roller pair 44 are located at a side of the left side wall of the cover 9. The first conveyance roller pair 43 is located at a higher position than the second conveyance roller pair 44.

The sheet discharge device 5 is located above the left end of the discharge tray 92. A specific configuration of the sheet discharge device 5 will be described in detail later.

The conveyance guide 30 has a first portion 31, a second portion 32, and a third portion 33. The first portion 31, the second portion 32, and the third portion 33 are formed by parts of a plurality of chute members located inside the cover 9, ribs protruding downward from the lower surface of the upper wall member of the cover 9, and so on.

The first portion 31 is a guide that guides the sheet SH from the left end of the supply tray 91 to the first conveyance roller pair 43.

The second portion 32 is a guide that guides the sheet SH from the second conveyance roller pair 44 toward the discharge tray 92, that is, to the sheet discharge device 5.

More specifically, the second portion 32 guides the sheet SH from the second conveyance roller pair 44 to the reading surface 3B so as to be inclined downward, and then causes the sheet SH to pass over the reading surface 3B, that is, above the reading sensor 3S at the stationary reading position. After that, the second portion 32 guides the sheet SH to the sheet discharge device 5 so as to be inclined upward.

The base member 95 has a discharge guide 96. The discharge guide 96 is located between the reading surface 3B and the left end of the discharge tray 92. The upper surface of the discharge guide 96 is inclined upward to the right from a position adjacent to the reading surface 3B to reach a top portion 96T. The upper surface of the discharge guide 96 defines, from below, a portion that guides the sheet SH in the second portion 32 so as to be inclined upward to the sheet discharge device 5.

The third portion 33 is connected to the first portion 31 and the second portion 32 at the side of the left side wall of the cover 9. The third portion 33 is a guide that guides the sheet SH from the first conveyance roller pair 43 to the second conveyance roller pair 44 so as to make a U-turn.

When the image scanner 3 reads images of the sheets SH supported by the supply tray 91, the conveyor 4 conveys the sheets SH supported by the supply tray 91 one sheet at a time. The first portion 31, the third portion 33, and the second portion 32 of the conveyance guide 30 guide the conveyed sheet SH to pass above the reading sensor 3S at the stationary reading position. Thereby, the reading sensor 3S reads the image on the surface of the sheet SH. Thereafter, the sheet discharge device 5 discharges the sheet SH from which the image has been read toward the discharge tray 92, and the discharge tray 92 supports the sheet SH.

<Configuration of Sheet Discharge Device>

As shown in FIGS. 3 to 5, the sheet discharge device 5 has a drive shaft 59, two discharge rollers 50, a support shaft 89, and two sets of follow rotation units 6.

The center axis of the drive shaft 59 and an axis X1 which is the center of the support shaft 89 are parallel to each other, and extend in the front-rear direction. The width direction of the sheet discharge device 5 is the front-rear direction parallel to the axis X1. In this embodiment, the front side is one side in the width direction, and the rear side is the other side in the width direction.

<Drive Shaft>

As shown in FIG. 3, the drive shaft 59 is a steel round bar extending in the width direction above the top portion 96T of the discharge guide 96. Shaft support portions 99A and 99B located at the front and rear ends of the base member 95 rotatably support both ends of the drive shaft 59 in the width direction.

Although not shown, the conveyor 4 has a drive source and a transmission mechanism that transmits a driving force generated by the drive source to the drive shaft 59. A gear 59G constitutes a part of the transmission mechanism, and transmits the driving force to the drive shaft 59 to rotate the drive shaft 59.

<Discharge Rollers>

The drive shaft 59 holds the two discharge rollers 50 so as to be rotatable together. Each discharge roller 50 is separated from each other in the width direction. Each discharge roller 50 has the same configuration.

Each discharge roller 50 is made of rubber, more specifically, ethylene propylene diene rubber (EPDM). The outer circumference of each discharge roller 50 is a cylindrical surface extending in the width direction without steps or unevenness. Each discharge roller 50 is compressed and deformed by being pressed by a member harder than itself.

Each discharge roller 50 rotates integrally with the drive shaft 59, and contacts the sheet SH passing through the top portion 96T of the discharge guide 96 from above. Thereby, each discharge roller 50 applies a conveyance force to the sheet SH and discharges the sheet SH to the discharge tray 92.

<Support Shaft Accommodating Portion, Spring Accommodating Portion, and Follow-Rotation-Unit Accommodating Portion>

The discharge guide 96 has a support shaft accommodating portion 96A, two spring accommodating portions 96B, and two follow-rotation-unit accommodating portions 96C.

The support shaft accommodating portion 96A is a groove recessed downward from the top portion 96T and extending in the width direction. Both ends of the support shaft accommodating portion 96A in the width direction are located outside the discharge rollers 50 in the width direction.

Each spring accommodating portion 96B is a bottomed hole that overlaps the support shaft accommodating portion 96A at a position that is inside the discharge rollers 50 in the width direction and apart from each other in the width direction, and is recessed downward from the top portion 96T. A compression coil spring 89S is located inside each of the spring accommodating portions 96B.

Each follow-rotation-unit accommodating portion 96C is a recess that overlaps the support shaft accommodating portion 96A below each discharge roller 50 and is recessed downward from the top portion 96T.

<Support Shaft>

The support shaft 89 is located within the support shaft accommodating portion 96A. The support shaft 89 is a steel round bar that extends to near both ends in the width direction of the support shaft accommodating portion 96A. The support shaft 89 extends around the axis X1. The compression coil spring 89S urges the support shaft 89 upward such that the support shaft 89 moves toward the drive shaft 59.

<Follow Rotation Unit>

Each of the follow rotation units 6 is located below each discharge roller 50 and inside the follow-rotation-unit accommodating portion 96C. Since each of the follow rotation units 6 has the same configuration, one of the follow rotation units 6 will be described, and the description of the other of the follow rotation units 6 will be omitted.

As shown in FIGS. 4 to 7, the follow rotation unit 6 has a follow roller 60, a holder 80, and two rubber members 7.

<Follow Roller>

As shown in FIGS. 6 to 10, the follow roller 60 is a member integrally having an anti-rotation protrusion 64, a contact portion 65, and an engagement portion 66. The follow roller 60 is made of resin, more specifically polyacetal resin (POM). That is, the follow roller 60 is harder than the discharge roller 50.

The follow roller 60 has a substantially cylindrical shape of which the center axis is the axis X1. An outer circumferential surface 60S of the follow roller 60 is a cylindrical surface that extends in the width direction without steps or unevenness. The outer circumferential surface 60S is an example of “outer circumference of the follow roller”. In a case where the surface of the follow roller 60 has steps or unevenness, the portion of the steps or unevenness farthest from the axis X1 forms the outer circumference of the follow roller 60.

As shown in FIG. 8, an inner circumferential surface 60T of the follow roller 60 is a cylindrical surface that extends in the width direction without steps or unevenness, except for the anti-rotation protrusion 64, the contact portion 65, and the engagement portion 66.

As shown in FIG. 5, a length W2 of the follow roller 60 in the width direction is smaller than a length W1 of the discharge roller 50 in the width direction. Ends 50E of the discharge roller 50 at one side and the other side in the width direction are located outside of edges 60E of the follow roller 60 at one side and the other side in the width direction, with respect to the width direction.

As shown in FIGS. 8 and 10, the contact portion 65 is an inner flange that protrudes radially inward of the axis X1 from the other end the inner circumferential surface 60T in the width direction. The contact portion 65 has a substantially C shape with a part cut out as viewed from the direction of the axis X1. Hereinafter, a radial direction of the axis X1 is simply referred to as “radial direction”.

The contact portion 65 has a contact surface 65A. The contact surface 65A is a surface facing one side in the width direction among the inner flange.

As shown in FIGS. 8 and 9, the anti-rotation protrusion 64 protrudes radially inward from the inner circumferential surface 60T of the follow roller 60 and extends in the width direction. The end of the anti-rotation protrusion 64 at the other side in the width direction is connected to the contact surface 65A. As shown in FIG. 9, the end of the anti-rotation protrusion 64 at one side in the width direction is separated from one end of the inner circumferential surface 60T in the width direction by a distance greater than the thickness of a flange portion 83 described later.

As shown in FIGS. 8 and 9, the engagement portion 66 is located on the inner circumferential surface 60T of the follow roller 60 at a position away from the cutout portion of the contact portion 65 toward one side in in the width direction. The engagement portion 66 (engagement protrusion) is a claw-like protrusion protruding radially inward. As shown in FIG. 9, the engagement portion 66 has a retainer surface 66A and an inclined surface 66B.

The retainer surface 66A protrudes radially inward from the inner circumferential surface 60T of the follow roller 60 and faces the other side in the width direction.

The inclined surface 66B extends from the tip edge of the retainer surface 66A so as to be inclined toward one side in the width direction and toward the inner circumferential surface 60T radially.

<Holder>

As shown in FIGS. 6, 7, 9 and 10, the holder 80 is a member having a shaft hole 80H, a first holding portion 81, and two second holding portions 82 that are formed integrally. The holder 80 is made of resin, more specifically polyacetal resin (POM).

The axis X1 is the axial center of the shaft hole 80H. The shaft hole 80H is formed to penetrate the first holding portion 81 and the second holding portions 82. Each second holding portion 82 is located outside the first holding portion 81 in the width direction.

As shown in FIGS. 9 and 10, the support shaft 89 enters the shaft hole 80H and holds the holder 80. In this state, the holder 80 is rotatable about the axis X1 relative to the support shaft 89.

As shown in FIGS. 6 and 7, the first holding portion 81 has two flange portions 83 and a contact protrusion 86.

The flange portions 83 protrude radially outward in a flange shape from positions separated from each other in the width direction. The flange portion 83 at the other side in the width direction has an anti-rotation recess 84 and an inclined recess 85.

The anti-rotation recess 84 is recessed radially inward from the outer circumferential edge of the flange portion 83. The inclined recessed 85 is recessed radially inward from the outer circumferential edge of the flange portion 83 at a position opposite to the anti-rotation recess 84 with respect to the axis X1. The bottom surface (inclined surface) of the inclined recess 85 is inclined to be radially outward from the other side toward one side in the width direction.

The contact protrusion 86 is connected to the outer circumferential edge of the flange portion 83 at the other side in the width direction, and protrudes toward the other side in the width direction.

Each of the second holding portions 82 has a first cylinder 82A and a second cylinder 82B, each having a cylindrical shape. The second cylinder 82B is located outside the first cylinder 82A in the width direction.

The first cylinder 82A has a smaller diameter than each flange portion 83. The second cylinder 82B has a smaller diameter than each flange portion 83 and a larger diameter than the first cylinder 82A.

As shown in FIG. 9, the holder 80 slides from one side to the other side in the width direction to enter the follow roller 60. Thereby, each flange portion 83 fits the inner circumferential surface 60T of the follow roller 60, and the anti-rotation recess 84 fits the anti-rotation protrusion 64.

At this time, in the follow roller 60, as shown in FIG. 10, the contact surface 65A of the contact portion 65 contacts the contact protrusion 86 of the first holding portion 81 from the other side in the width direction. And, as shown in FIG. 9, due to the inclined surface 66B, the engagement portion 66 gets (climbs) over the inclined recess 85 of the flange portion 83 at the other side in the width direction, and the retaining surface 66A contacts the flange portion 83 from one side in the width direction.

As a result, the first holding portion 81 holds the follow roller 60 from the inside. In this state, the follow roller 60 is integral with the holder 80 and is rotatable about the axis X1 together with the holder 80.

<Rubber Member>

As shown in FIGS. 6, 7, 9 and 10, each rubber member 7 is one member integrally having a paddle 70 and a groove (clearance portion) 75. Each rubber member 7 is made of rubber, more specifically, ethylene propylene diene rubber (EPDM).

In other words, the paddle 70 and the groove 75 are softer than the follow roller 60. Also, in this embodiment, the paddle 70 and the groove 75 are softer than the discharge roller 50.

The rubber member 7 has a substantially cylindrical shape. The rubber member 7 includes a flange-shaped paddle 70 and a rubber member main body. The rubber member main body is continuous from the paddle 70 so as to be located closer to the follow roller 60 than the paddle 70 is, and forms the groove 75. The paddle 70 is located outside the groove 75 in the width direction. The paddle 70 has a plurality of protrusions 71 and recesses 72 on the outer circumference of the flange shape. The protrusions 71 and the recesses 72 are alternately arranged in the circumferential direction of the axis X1. Hereinafter, the circumferential direction of the axis X1 is simply referred to as “circumferential direction”.

As shown in FIG. 7, the protrusion 71 protrudes farther radially outward than the outer circumferential surface 60S of the follow roller 60. That is, a distance L3 between the tip of the protrusion 71 and the axis X1 in the radial direction is greater than a distance L1 between the outer circumferential surface 60S of the follow roller 60 and the axis X1 in the radial direction.

The recess 72 is recessed radially inward between two protrusions 71 adjacent to each other in the circumferential direction. A distance L2 between the bottom of the recess 72 and the axis X1 in the radial direction is smaller than the distance L1.

A distance L4 between an outer circumferential surface of the groove 75 and the axis X1 in the radial direction is smaller than the distances L1 and L2. Thus, the groove 75 has a shape that is recessed one round toward the center in the radial direction from the follow roller 60. In other words, the groove 75 has a groove-shaped bottom between the follow roller 60 and the paddle 70.

The rubber member 7 has a substantially cylindrical shape having a through hole that is formed to penetrate in the width direction, and the through hole has two portions with different diameters. Of the through hole, a pressure contact hole 7H is formed at a radially inner side of the groove 75 and a portion of the paddle 70 located at the inner side of the protrusions 71 and the recesses 72 in the width direction. Of the through hole, the outer side in the width direction of the pressure contact hole 7H has a shape of a through hole having a diameter larger than that of the pressure contact hole 7H. The through hole having the larger diameter has an inner circumferential surface 70T. That is, the paddle 70 has the protrusions 71 and the recesses 72 on its outer circumference, and has the inner circumferential surface 70T on its inner circumference.

As shown in FIGS. 9 and 10, the second holding portion 82 of the holder 80 holds, from the inside, the paddle 70 and groove 75 of each rubber member 7 in a state where the first cylinder 82A enters the pressure contact hole 7H. In this state, the paddle 70 and the groove 75 rotate about the axis X1 integrally with the holder 80 and the follow roller 60.

The paddle 70 and the groove 75 are prevented from rotating relative to the holder 80 due to pressure contact between the first cylinder 82A and the groove 75 and a part of the paddle 70 via the pressure contact hole 7H. The second cylinder 82B retains the paddle 70 and the groove 75 relative to the holder 80.

As shown in FIG. 11, the paddles 70 are located at one side and the other side of the follow roller 60 in the width direction.

The groove 75 at one side in the width direction is located between the edge 60E of the follow roller 60 at one side in the width direction and the paddle 70 at one side in the width direction. Further, the groove 75 at one side in the width direction is located at the same position as the end 50E of the discharge roller 50 at one side in the width direction.

The groove 75 at the other side in the width direction is located between the edge 60E of the follow roller 60 at the other side in the width direction and the paddle 70 at the other side in the width direction. Further, the groove 75 at the other side in the width direction is located at the same position as the end 50E of the discharge roller 50 at the other side in the width direction.

Each groove 75 is recessed farther radially inward than the outer circumferential surface 60S of the follow roller 60.

Note that FIG. 11 exaggerates deformation of a portion of the discharge roller 50 that is pressed by the follow roller 60.

As shown in FIGS. 9 and 10, the inner circumferential surface 70T of the protrusions 71 and the recesses 72 of the paddle 70 is separated radially outward from the second holding portion 82. Ends 80E of the holder 80 at one end and the other end in the width direction protrude farther outward in the width direction than the paddle 70.

As shown in FIG. 11, the follow roller 60 nips the sheet SH together with the discharge roller 50 and rotates following the discharge roller 50. The protrusions 71 and the recesses 72 of the paddle 70 also rotate about the axis X1 integrally with the follow roller 60, and the protrusions 71 contact the sheet SH. Accordingly, when the trailing edge of the sheet SH enters the recess 72 of the paddle 70, the protrusion 71 contacts the trailing edge and kicks out the sheet SH.

<Operations and Effects>

In the sheet discharge device 5 of the embodiment, as shown in FIG. 11, the ends 50E of the discharge roller 50 at one side and the other side in the width direction press the sheet SH toward each groove 75 at a position between the follow roller 60 and each paddle 70. Here, the discharge roller 50 is softer than the follow roller 60. Thus, the sheet discharge device 5 causes the sheet SH to warp such that portions of the sheet SH located outside the follow roller 60 in the width direction enter the grooves 75 and approach the protrusions 71 and the recesses 72.

Thus, in the sheet discharge device 5, it is unlikely that kicking of the trailing edge of the sheet SH by the protrusions 71 and the recesses 72 is weakened. As a result, the sheet discharge device 5 suppresses problems that the trailing edge of the sheet SH stays near the follow roller 60, that the leading edge of the subsequent sheet SH slips under the trailing edge of the staying sheet SH to change the discharge order of the sheets SH, and that the subsequent sheet SH collides with the trailing edge of the staying sheet SH to cause damage or jamming of the sheet SH.

Thus, the sheet discharge device 5 of the embodiment suppresses discharge failures of the sheet SH. The same goes for the image scanning apparatus 1 of the embodiment including the sheet discharge device 5.

In the sheet discharge device 5, as shown in FIGS. 9 and 10, the paddle 70 and the groove 75 are one member and are softer than the follow roller 60. The holder 80 includes the first holding portion 81 that holds the follow roller 60 from the inside, and the second holding portion 82 located outside the first holding portion 81 in the width direction and holding the paddle 70 and the groove 75 from the inside. With this configuration, the paddle 70 and the groove 75 which are softer than the follow roller 60 are held by the second holding portion 82 of the holder 80 in a preferable manner. As a result, in the sheet discharge device 5, it is unlikely that kicking of the trailing edge of the sheet SH by the protrusions 71 and the recesses 72 is weakened.

In the sheet discharge device 5, the inner circumferential surface 70T of the protrusions 71 and the recesses 72 of the paddle 70 is separated from the second holding portion 82 radially outward. With this configuration, the second holding portion 82 is unlikely to prevent deformation of the protrusion 71 and the recess 72 of the paddle 70, and the protrusion 71 is easily deformed radially inward when pressed by the sheet SH. Thus, the sheet discharge device 5 prevents the contact pressure of the protrusions 71 against the sheet SH from becoming excessively large, and suppresses scraping of the protrusions 71. As a result, the sheet discharge device 5 improves the durability of the paddle 70.

In the sheet discharge device 5, as shown in FIG. 11, the ends 80E of the holder 80 at one end and the other end in the width direction protrude farther outward in the width direction than the paddle 70. With this configuration, the ends 80E of the holder 80 at one end and the other end in the width direction contact a frame holding the support shaft 89 and so on, more specifically, the follow-rotation-unit accommodating portion 96C of the base member 95 before the paddle 70 contacts the same. Thus, the sheet discharge device 5 suppresses scraping of a side surface of the paddle 70. As a result, the sheet discharge device 5 improves the durability of the paddle 70. Further, if the paddle 70 comes into contact with the frame holding the support shaft 89 and so on, the paddle 70 does not rotate and only the follow roller 60 rotates, which may weaken kicking of the trailing edge of the sheet SH. However, because the ends 80E of the holder 80 at one end and the other end in the width direction protrude farther outward in the width direction than the paddle 70, the paddle 70 is reliably rotated together with the follow roller 60.

In the sheet discharge device 5, as shown in FIG. 7, the distance L2 between the bottom of the recess 72 and the axis X1 in the radial direction is smaller than the distance L1 between the outer circumferential surface 60S of the follow roller 60 and the axis X1 in the radial direction. With this configuration, because the recesses 72 are recessed farther radially inward than the outer circumferential surface 60S of the follow roller 60, the deformability of the protrusion 71 is ensured by maximizing the distance between the tip of the protrusion 71 and the bottom of the recess 72 without increasing the protrusion amount of the protrusion 71. As a result, the sheet discharge device 5 suppresses the occurrence of impact noise and contact marks when the sheet SH contacts the protrusion 71, compared with a case where the protrusion amount of the protrusion 71 is increased.

In the sheet discharge device 5, as shown in FIGS. 6 and 9, the flange portion 83 at the other side in the width direction has the anti-rotation recess 84 and the inclined recess 85. The follow roller 60 has the anti-rotation protrusion 64. The holder 80 slides from one side to the other side in the width direction to enter the follow roller 60. Thereby, each flange portion 83 fits the inner circumferential surface 60T of the follow roller 60, and the anti-rotation recess 84 fits the anti-rotation protrusion 64. With this configuration, the follow roller 60 is attached to the holder 80 and the rotation of the follow roller 60 relative to the holder 80 is prevented with a single action.

In the sheet discharge device 5, as shown in FIGS. 8 and 10, the follow roller 60 has the contact portion 65 and the engagement portion 66. The holder 80 slides from one side to the other side in the width direction to enter the follow roller 60. Thereby, in the follow roller 60, as shown in FIG. 10, the contact surface 65A of the contact portion 65 contacts the first holding portion 81 from the other side in the width direction. And, as shown in FIG. 9, due to the inclined surface 66B, the engagement portion 66 gets one of the flange portion 83, and the retaining surface 66A contacts the flange portion 83 from one side in the width direction. With this configuration, the follow roller 60 is retained relative to the holder 80 with a single action.

In the sheet discharge device 5, the second holding portion 82 includes the first cylinder 82A in contact with the groove 75 and a part of the paddle 70 via the pressure contact hole 7H, and the second cylinder 82B located outside the first cylinder 82A in the width direction and having a larger diameter than the first cylinder 82A. With this configuration, the shape of the second holding portion 82 is simplified, and the paddle 70 and the groove 75, which are one member, are retained relative to the holder 80 by the second cylinder 82B.

In the sheet discharge device 5, the discharge roller 50 is made of rubber, and the follow roller 60 is made of resin. If the discharge roller 50 and the follow roller 60 are made of rubber, there is a possibility that an oil component and so on contained in the rubber will migrate from the follow roller 60 to the discharge roller 50 and change the outer diameter of the discharge roller 50. Then, when the outer diameter of the discharge roller 50 changes, the conveyance speed of the sheet SH by the discharge roller 50 fluctuates, and the image reading quality by the reading sensor 3S may deteriorate. In this regard, the sheet discharge device 5 and the image scanning apparatus 1 of the embodiment suppresses changes in the outer diameter of the discharge roller 50 due to the above configuration, and deterioration of the reading quality is suppressed.

In the sheet discharge device 5, as shown in FIG. 5, the length W2 of the follow roller 60 in the width direction is smaller than the length W1 of the discharge roller 50 in the width direction. As shown in FIG. 11, each paddle 70 is located at one side and the other side of the follow roller 60 in the width direction. Each groove 75 is located between the follow roller 60 and the paddle 70 at one side in the width direction and between the follow roller 60 and the paddle 70 at the other side in the width direction. With this configuration, it is unlikely that kicking of the trailing edge of the sheet SH by the protrusions 71 and the recesses 72 is weakened.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Thus, the disclosure is intended to embrace all known or later developed alternatives, modifications, variations, improvements, and/or substantial equivalents. Some specific examples of potential alternatives, modifications, or variations in the described invention are provided below:

In the embodiment, the paddle 70 and the groove 75 are one member (one piece), but the present disclosure is not limited to this configuration. For example, the follow roller and the groove may be one member. Further, the groove may be a member different from the follow roller and the paddle, for example, a part of the holder 80 in the embodiment. Further, the follow roller, the paddle and the groove may be one member.

In the embodiment, the discharge roller 50 is made of EPDM, but the present disclosure is not limited to this configuration. For example, the discharge roller may be made of rubber different from EPDM, or may be made of resin that is softer than the follow roller.

In the embodiment, the follow roller 60 is made of POM, but the present disclosure is not limited to this configuration. For example, the follow roller may be made of resin or rubber different from POM, provided that the follow roller is harder than the discharge roller.

In the embodiment, two sets of the paddles 70 and the grooves 75 are located at one side and the other side of the follow roller 60 in the width direction, but the present disclosure is not limited to this configuration. For example, the paddle and the groove may be provided at only one side of the follow roller in the width direction.

In the embodiment, the sheet discharge device of the present disclosure is embodied as the sheet discharge device 5 included in the image scanning apparatus 1, but the present disclosure is not limited to this configuration. For example, the present disclosure may be applied to a sheet discharge device included in an image forming apparatus that forms an image on a sheet. Further, the present disclosure may be applied to a sheet discharge device of an image forming apparatus or an image scanner in a multifunction peripheral (MFP) including the image scanner at the upper side of the image forming apparatus.

In the embodiment, regarding the recess 72 of the paddle 70, the distance L2 between the bottom of the recess 72 and the axis X1 in the radial direction is smaller than the distance L1 between the outer circumferential surface 60S of the follow roller 60 and the axis X1 in the radial direction. The present disclosure is not limited to this configuration. For example, the distance L2 may be greater than the distance L1.

What is claimed is:

1. A sheet discharge device comprising:
a discharge roller rotatable to apply a conveyance force to a sheet and discharge the sheet;
a follow roller rotatable about an axis, the follow roller being configured to nip the sheet with the discharge roller and to rotate by following rotation of the discharge roller, the follow roller being harder than the discharge roller;
a paddle rotatable together with the follow roller, the paddle including protrusions and recesses arranged alternately in a circumferential direction of the axis, each of the protrusions protruding farther radially outward than an outer circumference of the follow roller to contact the sheet, each of the recesses being recessed radially inward between two of the protrusions adjacent to each other in the circumferential direction; and
a groove located between the follow roller and the paddle in a width direction, the width direction being parallel to a direction in which the axis extends, the groove being located at a same position as an end of the discharge roller in the width direction, the groove being recessed one round farther radially inward than the outer circumference of the follow roller.

2. The sheet discharge device according to claim 1, further comprising:
a support shaft extending along the axis; and
a holder rotatable about the axis relative to the support shaft,
wherein the paddle and the groove are one member that is softer than the follow roller; and
wherein the holder includes:
a first holding portion holding the follow roller from inside; and
a second holding portion located outside the first holding portion in the width direction, the second holding portion holding the paddle and the groove from inside.

3. The sheet discharge device according to claim 2, wherein an inner circumferential surface of the paddle is radially separated from the second holding portion.

4. The sheet discharge device according to claim 2, wherein an end of the holder in the width direction protrudes farther outward in the width direction than the paddle does.

5. The sheet discharge device according to claim 2, wherein a distance between a bottom of the recesses and the axis in a radial direction is smaller than a distance between an outer circumference of the follow roller and the axis in the radial direction.

6. The sheet discharge device according to claim 2, wherein the first holding portion includes a plurality of flanges each protruding radially in a flange shape from positions separated from each other in the width direction;
wherein at least one of the plurality of flanges has an anti-rotation recess that is recessed radially from an outer circumference edge of the at least one of the plurality of flanges;
wherein the follow roller includes an anti-rotation protrusion protruding radially from an inner circumferential surface of the follow roller and extending in the width direction; and
wherein the holder is configured to slide into the follow roller in the width direction, each of the plurality of flanges fits the inner circumferential surface of the follow roller, and the anti-rotation recess fits the anti-rotation protrusion.

7. The sheet discharge device according to claim 6, wherein the follow roller includes:
an inner flange protruding radially from the inner circumferential surface of the follow roller, the inner flange having a contact surface facing one side in the width direction; and
an engagement protrusion protruding radially from the inner circumferential surface of the follow roller, the engagement protrusion having a retainer surface and an inclined surface, the retainer surface facing an other side in the width direction, the inclined surface extending from a tip edge of the retainer surface so as to be inclined toward the one side in the width direction and toward the inner circumferential surface radially; and
wherein the holder is configured to slide into the follow roller from the one side toward the other side in the width direction, the contact surface of the inner flange contacts the first holding portion from the other side in the width direction, the inclined surface of the engagement protrusion gets over one of the plurality of flanges, and the retainer surface contacts the one of the plurality of flanges from the one side in the width direction.

8. The sheet discharge device according to claim 2, wherein the second holding portion includes:
a first cylinder in pressure contact with at least the groove; and
a second cylinder located outside the first cylinder in the width direction, the second cylinder having a larger diameter than the first cylinder.

9. The sheet discharge device according to claim 1, wherein the discharge roller is made of rubber, and the follow roller is made of resin.

10. The sheet discharge device according to claim 1, wherein a length of the follow roller in the width direction is smaller than a length of the discharge roller in the width direction;
wherein the paddle is located at one side and an other side of the follow roller in the width direction; and
wherein the groove is located between the follow roller and the paddle at the one side in the width direction and between the follow roller and the paddle at the other side in the width direction.

11. An image scanning apparatus comprising:
an image scanner configured to scan an image on a sheet; and
a sheet discharge device configured to discharge the sheet, the sheet discharge device comprising:
a discharge roller rotatable to apply a conveyance force to the sheet and discharge the sheet;
a follow roller rotatable about an axis, the follow roller being configured to nip the sheet with the discharge roller and to rotate by following rotation of the discharge roller, the follow roller being harder than the discharge roller;
a paddle rotatable together with the follow roller, the paddle including protrusions and recesses arranged alternately in a circumferential direction of the axis, each of the protrusions protruding farther radially outward than an outer circumference of the follow roller to contact the sheet, each of the recesses being recessed radially inward between two of the protrusions adjacent to each other in the circumferential direction; and
a groove located between the follow roller and the paddle in a width direction, the width direction being parallel to a direction in which the axis extends, the groove being located at a same position as an end of the discharge roller in the width direction, the groove being recessed one round farther radially inward than the outer circumference of the follow roller.

12. The image scanning apparatus according to claim 11, wherein the sheet discharge device further comprises:
a support shaft extending along the axis; and
a holder rotatable about the axis relative to the support shaft,
wherein the paddle and the groove are one member that is softer than the follow roller; and
wherein the holder includes:
a first holding portion holding the follow roller from inside; and
a second holding portion located outside the first holding portion in the width direction, the second holding portion holding the paddle and the groove from inside.

13. The image scanning apparatus according to claim 12, wherein an inner circumferential surface of the paddle is radially separated from the second holding portion.

14. The image scanning apparatus according to claim 12, wherein an end of the holder in the width direction protrudes farther outward in the width direction than the paddle does.

15. The image scanning apparatus according to claim 12, wherein a distance between a bottom of the recesses and the axis in a radial direction is smaller than a distance between an outer circumference of the follow roller and the axis in the radial direction.

16. The image scanning apparatus according to claim 12, wherein the first holding portion includes a plurality of flanges each protruding radially in a flange shape from positions separated from each other in the width direction;
wherein at least one of the plurality of flanges has an anti-rotation recess that is recessed radially from an outer circumference edge of the at least one of the plurality of flanges;
wherein the follow roller includes an anti-rotation protrusion protruding radially from an inner circumferential surface of the follow roller and extending in the width direction; and
wherein the holder is configured to slide into the follow roller in the width direction, each of the plurality of flanges fits the inner circumferential surface of the follow roller, and the anti-rotation recess fits the anti-rotation protrusion.

17. The image scanning apparatus according to claim 16, wherein the follow roller includes:
an inner flange protruding radially from the inner circumferential surface of the follow roller, the inner flange having a contact surface facing one side in the width direction; and
an engagement protrusion protruding radially from the inner circumferential surface of the follow roller, the engagement protrusion having a retainer surface and an inclined surface, the retainer surface facing an other side in the width direction, the inclined surface extending from a tip edge of the retainer surface so as to be inclined toward the one side in the width direction and toward the inner circumferential surface radially; and
wherein the holder is configured to slide into the follow roller from the one side toward the other side in the width direction, the contact surface of the inner flange contacts the first holding portion from the other side in the width direction, the inclined surface of the engagement protrusion gets over one of the plurality of flanges, and the retainer surface contacts the one of the plurality of flanges from the one side in the width direction.

18. The image scanning apparatus according to claim 12, wherein the second holding portion includes:
a first cylinder in pressure contact with at least the groove; and
a second cylinder located outside the first cylinder in the width direction, the second cylinder having a larger diameter than the first cylinder.

19. The image scanning apparatus according to claim 11, wherein the discharge roller is made of rubber, and the follow roller is made of resin.

20. The image scanning apparatus according to claim 11, wherein a length of the follow roller in the width direction is smaller than a length of the discharge roller in the width direction;
wherein the paddle is located at one side and an other side of the follow roller in the width direction; and
wherein the groove is located between the follow roller and the paddle at the one side in the width direction and between the follow roller and the paddle at the other side in the width direction.
